(19) United States
(12) Patent Application Publication
(10) Pub. No.: US 2026/0101140 A1
(43) Pub. Date: Apr. 9, 2026

(54) SPEAKER

(71) Applicant: AAC Microtech (Changzhou) Co., Ltd., Changzhou City (CN)

(72) Inventor: Lubin Mao, Changzhou (CN)

(21) Appl. No.: 18/988,830

(22) Filed: Dec. 19, 2024

Related U.S. Application Data
(63) Continuation of application No. PCT/CN2024/123393, filed on Oct. 8, 2024.

(51) Int. Cl. H04R 1/40; H04R 9/02; H04R 9/04; H04R 9/06

(52) U.S. Cl. CPC H04R 1/403; H04R 9/025; H04R 9/045; H04R 9/06; H04R 2400/11

(57) ABSTRACT

The present disclosure relates to the technical field of electro-acoustic conversion and provides a speaker. The vibration system of the speaker includes a main sound production unit and at least one auxiliary sound production unit. The magnetic circuit system drives the main sound production unit to vibrate and produce sound in a first direction, and drives the auxiliary sound production unit to vibrate and produce sound in a second direction. The first direction and the second direction are perpendicular to each other. Since the magnetic circuit system is shared by the main sound production unit and the auxiliary sound production unit, effects of reducing the costs and the mounting difficulty, achieving reliable connections, improving the performance of the speaker can be achieved.

### CROSS-REFERENCE TO RELATED APPLICATIONS

This application is a continuation of International Application No. PCT/CN2024/123393, filed on Oct. 8, 2024, the entire content of which is incorporated herein by reference.

### TECHNICAL FIELD

The present disclosure relates to the technical field of electro-acoustic conversion, and in particular, to a speaker.

### BACKGROUND

With the popularization of mobile electronic equipment, the mobile electronic equipment is gradually developed towards multifunctionality. A high-quality music function has become one of commonly used functions of the mobile electronic device, and speakers for playing sound are widely applied to the mobile electronic equipment. The speakers in the related technology generally produce sound on a single side, and their frequency response is limited by their sizes, making it difficult to achieve full frequency band performance improvement.

To achieve a better sound effect, the speakers are generally designed to produce sound on both sides, namely, double-sided speakers. The double-sided speaker includes two sets of magnetic circuit systems and vibration systems. The two sets of magnetic circuit systems play a role separately and are each matched with one vibration system to achieve the purpose that the speaker has a better sound effect. Due to the arrangement of the two sets of magnetic circuit systems, the double-sided speaker has increase costs, and it is difficult to connect and mount the double-sided speaker, which can easily lead to unreliable connections and affect the overall performance of the speaker.

Therefore, it is necessary to provide a new speaker.

### SUMMARY

The present disclosure aims to provide a speaker, which can solve the following problem: Due to arrangement of two sets of magnetic circuit systems, a double-sided speaker has increase costs and unreliable connections, which affects the overall performance of the speaker.

The technical scheme provided by the present disclosure is as follows.

A speaker includes a stand, a vibration system and a magnetic circuit system which are respectively fixed to the stand. The magnetic circuit system drives the vibration system to vibrate and produce sound. The vibration system includes a main sound production unit and at least one auxiliary sound production unit. The magnetic circuit system drives the main sound production unit to vibrate and produce sound in a first direction, and drives the auxiliary sound production unit to vibrate and produce sound in a second direction. The first direction and the second direction are perpendicular to each other.

Preferably, the magnetic circuit system includes a main magnetic yoke, a main magnetic portion fixed to the main magnetic yoke, a main electrode plate covering one side of the main magnetic portion away from the main magnetic yoke, an auxiliary magnetic portion arranged around the main magnetic portion and spaced apart from the main magnetic portion to form a first magnetic gap, an edge magnetic portion arranged on one side of the auxiliary magnetic portion away from the main magnetic portion and spaced apart from the auxiliary magnetic portion to form a second magnetic gap, and a ringlike auxiliary magnetic yoke fixed to one side of the auxiliary magnetic portion away from the main magnetic yoke. The auxiliary magnetic yoke is fixed to the stand.

Preferably, the stand is rectangular and includes two first side walls extending in a long axis direction and spaced apart from each other, and two second side walls extending in a short axis direction and spaced apart from each other. The auxiliary magnetic portion includes two first auxiliary magnets spaced apart in the short axis direction and two second auxiliary magnets spaced apart in the long axis direction. The edge magnetic portion is arranged on sides of the first auxiliary magnets away from the main magnetic portion.

Preferably, each first auxiliary magnet includes a main body section and a step section arranged on one side of the main body section close to the edge magnetic portion. In the first direction, a height of the step section is less than a height of the main body section. The height of the main body section is the same as a height of each second auxiliary magnet. The height of the step section is the same as a height of the edge magnetic portion. The auxiliary yoke, the first auxiliary magnet, and the edge magnetic portion are enclosed to form an accommodating chamber.

Preferably, the main sound production unit includes a first vibrating diaphragm fixed to the stand, a first frame fixed to one side of the first vibrating diaphragm facing the magnetic circuit system, a first voice coil fixed to the first frame and inserted into the first magnetic gap, and two elastic supporting members spaced apart in the long axis direction on opposite sides of the first voice coil. The elastic supporting members are fixed to the first frame and the stand.

Preferably, the auxiliary sound production unit includes a second vibrating diaphragm fixed to the first side walls of the stand and the main magnetic yoke, a second voice coil accommodated in the accommodating chamber, and a connector for connecting the second vibrating diaphragm to the second voice coil. The auxiliary sound production unit uses a side magnet to: drive the second voice coil to vibrate in the second direction in the accommodating chamber and drive the second vibrating diaphragm to vibrate and produce sound. The side magnet includes the side magnetic portion and the first auxiliary magnets.

Preferably, the connector includes a first vertical section extending in the first direction, a horizontal section extending in the second direction, and a second vertical section extending in the first direction. The second vibrating diaphragm is fixed to the first vertical section. The second voice coil is fixed to the second vertical section.

Preferably, the second vibrating diaphragm includes a ring-like folded ring portion with an arc structure, a vibrating portion connected to an inner edge of the folded ring portion, and a fixed portion connected to an outer edge of the folded ring portion. Two opposite sides of the fixed portion are respectively fixed to the stand and the main magnetic yoke. The folded ring portion protrudes away from the magnetic circuit system.

Preferably, a magnetization magnetic circuit for the edge magnetic portion and the first auxiliary magnets is a two-stage magnetization magnetic circuit, and achieves integrated stage-by-stage magnetization or separate magnetization.

Preferably, the vibration system includes two auxiliary sound production units, and the two auxiliary sound production units are oppositely spaced apart from each other in the short axis direction.

Beneficial effects: The vibration system includes a main sound production unit and at least one auxiliary sound production unit. The magnetic circuit system drives the main sound production unit to vibrate and produce sound in a first direction, and drives the auxiliary sound production unit to vibrate and produce sound in a second direction. The first direction and the second direction are perpendicular to each other. Since the magnetic circuit system is shared by the main sound production unit and the auxiliary sound production unit, effects of reducing the costs and the mounting difficulty, achieving reliable connections, improving the performance of the speaker can be achieved.

### BRIEF DESCRIPTION OF THE DRAWINGS

FIG. 1 is a schematic diagram of a three-dimensional structure of a speaker according to an embodiment of the present disclosure;

FIG. 2 is a schematic diagram of an exploded structure of a speaker according to an embodiment of the present disclosure;

FIG. 3 is a cross-sectional view of FIG. 1 along line A-A;

FIG. 4 is a cross-sectional view of FIG. 1 along line B-B;

FIG. 5 is a schematic structural diagram of a connector according to an embodiment of the present disclosure; and

FIG. 6 is a schematic structural diagram of assembling of a magnetic circuit system and an auxiliary sound production unit according to an embodiment of the present disclosure.

### DETAILED DESCRIPTION OF THE EMBODIMENTS

The specific embodiments of the present disclosure are described in details in combination with the drawings.

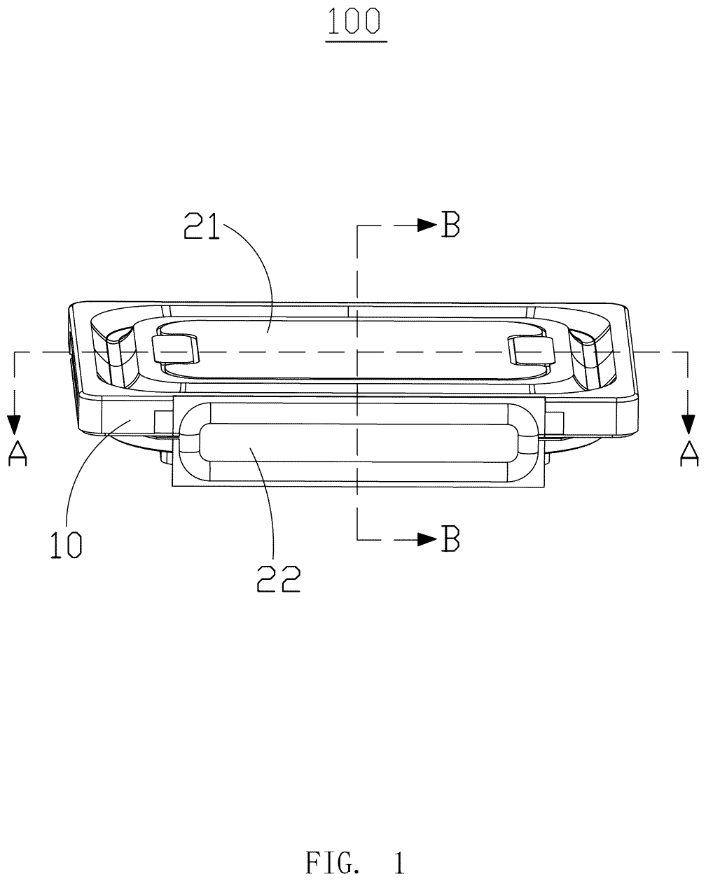

Referring to FIG. 1 to FIG. 4, a speaker 100 according to an embodiment of the present disclosure includes a stand 10, a vibration system 20, and a magnetic circuit system 30.

Referring to FIG. 1 to FIG. 4, the stand 10 is used for supporting the vibration system 20 and the magnetic circuit system 30. The magnetic circuit system 30 has a first magnetic gap 301. The magnetic circuit system 30 is used for driving the vibration system 20 to vibrate and produce sound. In this embodiment, the stand 10 is rectangular and includes two first side walls 11 extending in a long axis direction and spaced apart from each other, and two second side walls 12 extending in a short axis direction and spaced apart from each other.

Referring to FIG. 1 to FIG. 4, the vibration system 20 includes a main sound production unit 21 and at least one auxiliary sound production unit 22. The magnetic circuit system 30 drives the main sound production unit 21 to vibrate and produce sound in a first direction, and drives the auxiliary sound production unit 22 to vibrate and produce sound in a second direction. The first direction and the second direction are perpendicular to each other. In this embodiment, the first direction is a Z direction and the second direction is an X direction. Since the magnetic circuit system 30 is shared by the main sound production unit 21 and the auxiliary sound production unit 22, effects of reducing the costs and the mounting difficulty, achieving reliable connections, improving the performance of the speaker 100 can be achieved.

There may be one or two auxiliary sound production units 22, and a specific quantity can be designed according to an actual need. In this embodiment, the vibration system 20 includes two auxiliary sound production units 22. The two auxiliary sound production units 22 are oppositely spaced apart in the short axis direction and are respectively fixed to the first side walls 11 of the stand 10.

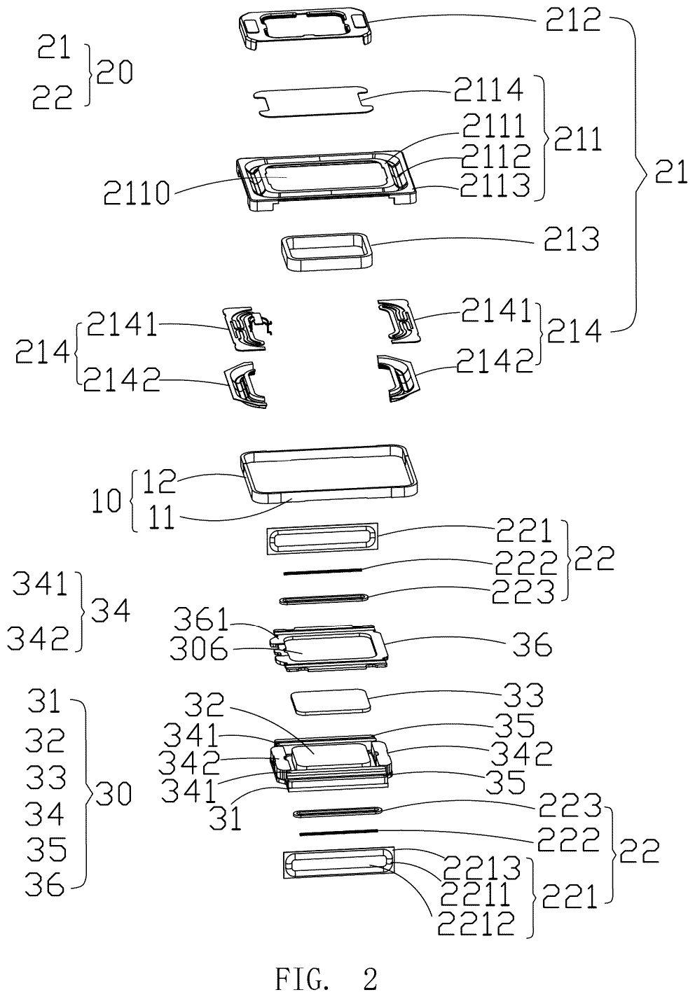

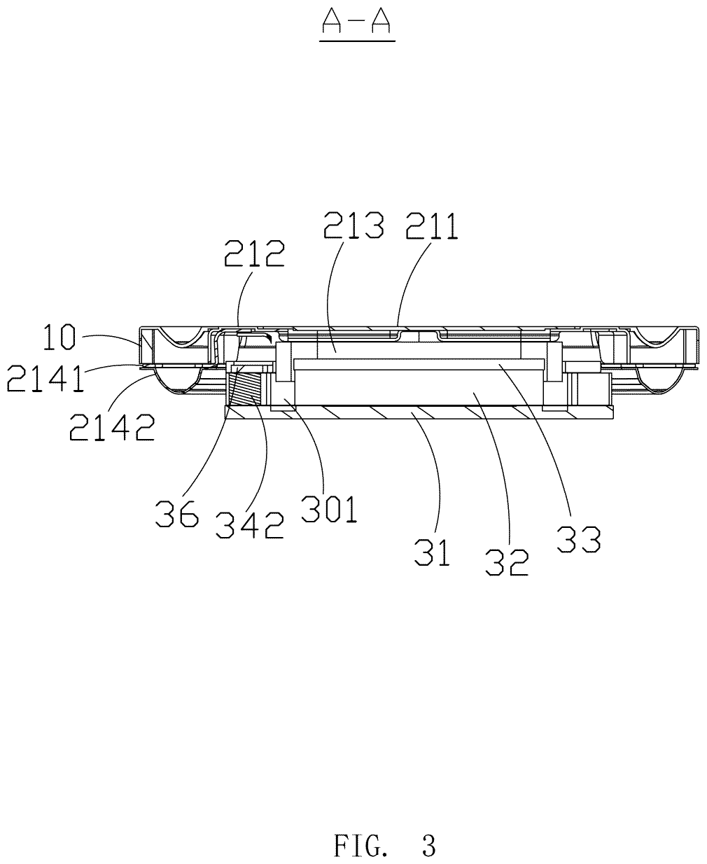

Referring to FIG. 2 and FIG. 3, the main sound production unit 21 includes a first vibrating diaphragm 211 fixed to the stand 10, a first frame 212 fixed to one side of the first vibrating diaphragm 211 facing the magnetic circuit system 30, a first voice coil 213 fixed to the first frame 212 and inserted into the first magnetic gap 301, and two elastic supporting members 214 spaced apart in the long axis direction on opposite sides of the first voice coil 213; and the elastic supporting members 214 are fixed to the first frame 212 and the stand 10. When the speaker 100 is powered on, the first voice coil 213 vibrates in the first direction under the action of the magnetic circuit system 30, and drives the first frame 212 to drive the first vibrating diaphragm 211 and the elastic supporting members 214 to vibrate and produce sound in the first direction. The arrangement of the elastic supporting members 214 is used to suppress lateral swinging of the first voice coil 213, thereby achieving a better sound production effect.

Specifically, referring to FIG. 2 and FIG. 3, the first vibrating diaphragm 211 includes a first vibrating portion 2111, a first folded ring portion 2112 extending in a bent manner from a peripheral edge of the first vibrating portion 2111, a first fixed portion 2113 extending in a bent manner outward from one side of the first folded ring portion 2112 away from the first vibrating portion 2111, a through port 2110 penetrating through the first vibrating portion 2111 in the first direction, and a dome 2114 covering the first vibrating portion 2111 and completely covering the through port 2110. The first fixed portion 2113 is fixed to the stand 10. The first vibrating portion 2111 is fixed to the first frame 212. The first folded ring portion 2112 is of an arc structure and protrudes towards one side of the magnetic circuit system 30.

One side of the first frame 212 facing away from the magnetic circuit system 30 is connected to the first vibrating diaphragm 211, and one side of the first frame 212 facing the magnetic circuit system 30 is connected to the first voice coil 213 and supported and fixed to the elastic supporting members 214.

Referring to FIG. 2 and FIG. 3, each elastic supporting member 214 includes a flexible printed circuit board 2141 and a buffer vibrating diaphragm 2142 which are stacked in the first direction. The flexible printed circuit board 2141 is fixed to the stand 10 and the first frame 212, respectively. The flexible printed circuit board 2141 is electrically connected to the first voice coil 213. The buffer vibrating diaphragm 2142 is of an arc-shaped structure, and a protruding direction of the buffer vibrating diaphragm 2142 is the same as that of the first vibrating diaphragm 211. Specifically, the first vibrating diaphragm 211 protrudes towards one side of the magnetic circuit system 30, and the buffer vibrating diaphragm 2142 also protrudes towards one side of the magnetic circuit system 30.

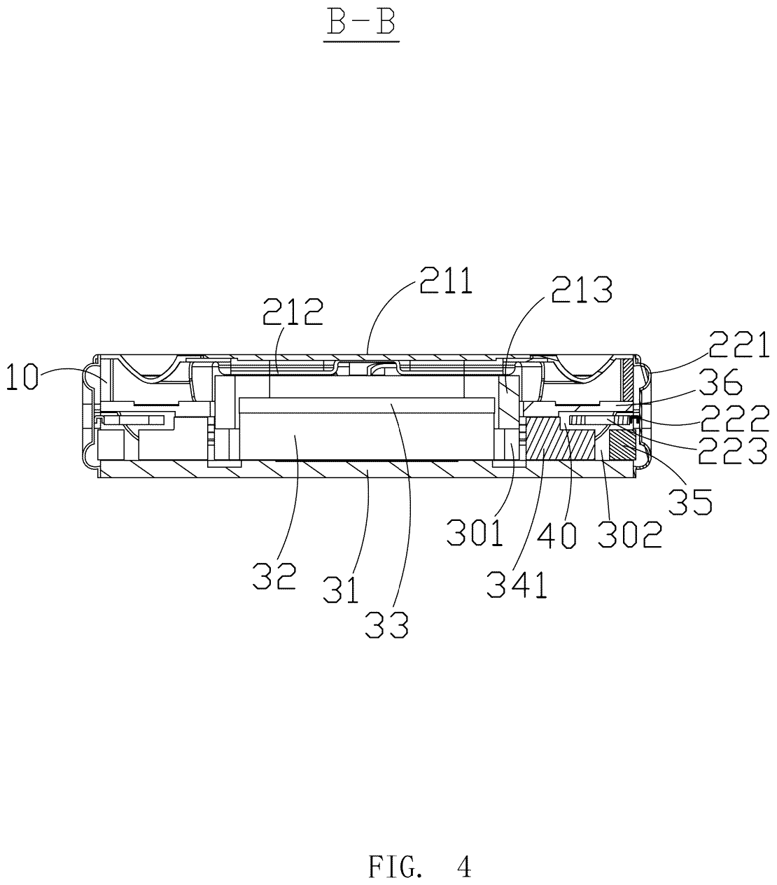

Referring to FIG. 2 and FIG. 4, each auxiliary sound production unit 22 includes a second vibrating diaphragm 221 fixed to the first side walls 11 of the stand 10, a connector 222 connected to the second vibrating diaphragm 221, and a second voice coil 223 connected to the connector 222. The magnetic circuit system 30 drives the second voice coil 223 vibrates in the second direction and drives the second vibrating diaphragm 221 to vibrate and produce sound. Since the speaker in the related technology achieves single-sided sound production through the main sound production unit 21, and the frequency response is limited to the size of the product, it is difficult to achieve full frequency band performance improvement. In this embodiment, Z-direction sound production is achieved through the main sound production unit 21. Meanwhile, X-direction sound production from a side surface is added through the auxiliary sound production units 22, which can supplement the performance defect of the main sound production unit 21, such as high-frequency peaks and valleys.

Specifically, referring to FIG. 2, each second vibrating diaphragm 221 includes a ring-like folded ring portion 2211 with an arc structure, a second vibrating portion 2212 connected to an inner edge of the folded ring portion 2211, and a second fixed portion 2213 connected to an outer edge of the folded ring portion 2211. The second fixed portion 2213 is fixed to the stand 10, and the second folded ring portion 2211 protrudes away from one side of the magnetic circuit system 30.

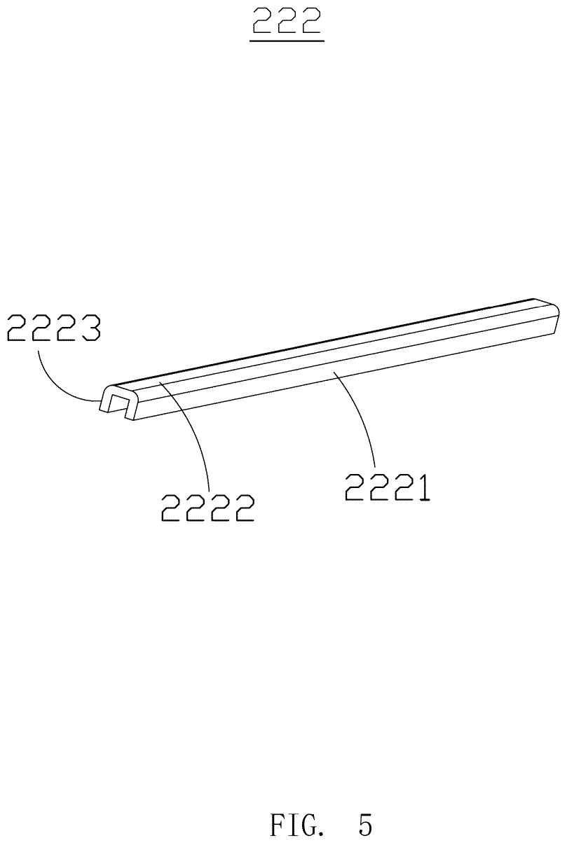

Referring to FIG. 5, each connector 222 includes a first vertical section 2221 extending in the first direction, a horizontal section 2222 extending in the second direction, and a second vertical section 2223 extending in the first direction. The first vertical section 2221, the horizontal section 2222, and the second vertical section 2223 are jointly enclosed to form a U-shaped groove. The second vibrating diaphragm 221 is fixed to the first vertical section 2221, and the second voice coil 223 is fixed to the second vertical section 2223.

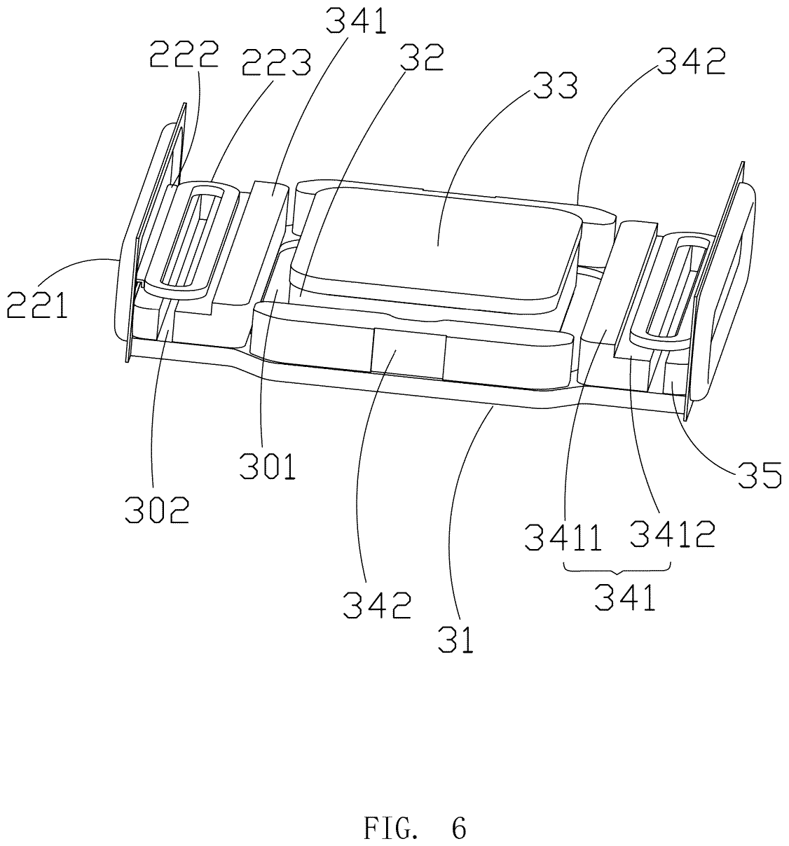

Referring to FIG. 2 to FIG. 4, and FIG. 6, the magnetic circuit system 30 includes a main magnetic yoke 31, a main magnetic portion 32 fixed to the main magnetic yoke 31, a main electrode plate 33 covering one side of the main magnetic portion 32 away from the main magnetic yoke 31, an auxiliary magnetic portion 34 arranged around the main magnetic portion 32 and spaced apart from the main magnetic portion 32 to form the first magnetic gap 301, an edge magnetic portion 35 arranged on one side of the auxiliary magnetic portion 34 away from the main magnetic portion 32 and spaced apart from the auxiliary magnetic portion 34 to form a second magnetic gap 302, and a ringlike auxiliary magnetic yoke 36 fixed to the side of the auxiliary magnetic portion 34 away from the main magnetic yoke 31.

The main magnetic yoke 31 can be used for magnetic conduction to improve a driving force. The main magnetic yoke 31 fixes the main magnetic portion 32, the auxiliary magnetic portion 34, and the edge magnetic portion 35, and the main magnetic yoke 31 further fixes the second fixed portions 2213 of the second vibrating diaphragms 221. The auxiliary magnetic portion 34 is arranged around a peripheral side of the main magnetic portion 32.

Referring to FIG. 2 and FIG. 4, the auxiliary magnetic yoke 36 is fixed to the stand 10. The auxiliary magnetic yoke 36 is annular, and includes an annular connecting portion 361 and a cavity 306 formed in the connecting portion 361. The connecting portion 361 of the auxiliary magnetic yoke 36 fixes the auxiliary magnetic portion 34, and the first voice coil 213 is arranged in the cavity 306 in a penetrating manner and inserted into the first magnetic gap 301.

The auxiliary magnetic portion 34 includes two first auxiliary magnets 341 oppositely spaced apart from each other in the short axis direction, and two second auxiliary magnets 342 oppositely spaced apart from each other in the long axis direction.

Referring to FIG. 6, each first auxiliary magnet 341 includes a main body section 3411 and a step section 3412 arranged on one side of the main body section 3411 close to the edge magnetic portion 35; in the first direction, a height of the step section 3412 is less than a height of the main body section 3411; the height of the main body section 3411 is the same as a height of each second auxiliary magnet 342; and the height of the step section 3412 is the same as a height of each edge magnetic portion 35.

Referring to FIG. 4 and FIG. 6, the edge magnetic portion 35 is arranged on sides of the first auxiliary magnets 341 away from the main magnetic portion 32. The edge magnetic portion 35 and the first auxiliary magnets 341 form an edge magnet, and the auxiliary yoke 36, the first auxiliary magnets 341, and the edge magnetic portion 35 are enclosed to form an accommodating chamber 40. The auxiliary sound production units 22 use the edge magnets to: drive the second voice coils 223 to vibrate in the second direction in the accommodating chamber 40, and drive the second vibrating diaphragms 221 to vibrate and produce sound.

Further, a magnetization magnetic circuit for the edge magnet is a two-stage magnetization magnetic circuit, and the edge magnet can be integrally magnetized stage by stage or can be separately magnetized. In this embodiment, the edge magnets are magnetized separately, namely, a magnetization magnetic circuit for the edge magnetic portion 35 and the first auxiliary magnets 341 is a two-stage magnetization magnetic circuit, and achieves separate magnetization. In this embodiment, there are two edge magnetic portions 35. One edge magnetic portion 35 is matched with one first auxiliary magnet 341.

The main electrode plate 33 is used for magnetic conduction to improve a driving force.

In this embodiment of the present disclosure, the first auxiliary magnets 341 are symmetrically arranged, the second auxiliary magnets 342 are symmetrically arranged, and the first auxiliary magnets 341 are shared magnets, which further improves the magnetic circuit symmetry of the magnetic circuit system 30, and reduces the costs and assembling difficulties, thereby improving the sound production performance of the speaker 100.

The above is only the preferred embodiments of the present disclosure. It should be noted that those of ordinary skill in the art can further make improvements without departing from the concept of the present disclosure. These improvements shall all fall within the protection scope of the present disclosure.

What is claimed is:

1. A speaker, comprising a stand, and a vibration system and a magnetic circuit system which are respectively fixed to the stand, wherein the magnetic circuit system drives the vibration system to vibrate and produce sound; the vibration system comprises a main sound production unit and at least one auxiliary sound production unit; the magnetic circuit system drives the main sound production unit to vibrate and produce sound in a first direction, and drives the auxiliary sound production unit to vibrate and produce sound in a second direction; and the first direction and the second direction are perpendicular to each other.

2. The speaker according to claim 1, wherein the magnetic circuit system comprises a main magnetic yoke, a main magnetic portion fixed to the main magnetic yoke, a main electrode plate covering one side of the main magnetic portion away from the main magnetic yoke, an auxiliary magnetic portion arranged around the main magnetic portion and spaced apart from the main magnetic portion to form a first magnetic gap, an edge magnetic portion arranged on one side of the auxiliary magnetic portion away from the main magnetic portion and spaced apart from the auxiliary magnetic portion to form a second magnetic gap, and a ringlike auxiliary magnetic yoke fixed to one side of the auxiliary magnetic portion away from the main magnetic yoke; and the auxiliary magnetic yoke is fixed to the stand.

3. The speaker according to claim 2, wherein the stand is rectangular and comprises two first side walls extending in a long axis direction and spaced apart from each other, and two second side walls extending in a short axis direction and spaced apart from each other; the auxiliary magnetic portion comprises two first auxiliary magnets spaced apart in the short axis direction and two second auxiliary magnets spaced apart in the long axis direction; and the edge magnetic portion is arranged on sides of the first auxiliary magnets away from the main magnetic portion.

4. The speaker according to claim 3, wherein each first auxiliary magnet comprises a main body section and a step section arranged on one side of the main body section close to the edge magnetic portion; in the first direction, a height of the step section is less than a height of the main body section; the height of the main body section is the same as a height of each second auxiliary magnet; the height of the step section is the same as a height of the edge magnetic portion; and the auxiliary yoke, the first auxiliary magnet, and the edge magnetic portion are enclosed to form an accommodating chamber.

5. The speaker according to claim 4, wherein the main sound production unit comprises a first vibrating diaphragm fixed to the stand, a first frame fixed to one side of the first vibrating diaphragm facing the magnetic circuit system, a first voice coil fixed to the first frame and inserted into the first magnetic gap, and two elastic supporting members spaced apart in the long axis direction on opposite sides of the first voice coil; and the elastic supporting members are fixed to the first frame and the stand.

6. The speaker according to claim 4, wherein the auxiliary sound production unit comprises a second vibrating diaphragm fixed to the first side walls of the stand and the main magnetic yoke, a second voice coil accommodated in the accommodating chamber, and a connector for connecting the second vibrating diaphragm to the second voice coil; the auxiliary sound production unit uses a side magnet to: drive the second voice coil to vibrate in the second direction in the accommodating chamber and drive the second vibrating diaphragm to vibrate and produce sound; and the side magnet comprises the side magnetic portion and the first auxiliary magnets.

7. The speaker according to claim 6, wherein the connector comprises a first vertical section extending in the first direction, a horizontal section extending in the second direction, and a second vertical section extending in the first direction; the second vibrating diaphragm is fixed to the first vertical section; and the second voice coil is fixed to the second vertical section.

8. The speaker according to claim 6, wherein the second vibrating diaphragm comprises a ring-like folded ring portion with an arc structure, a vibrating portion connected to an inner edge of the folded ring portion, and a fixed portion connected to an outer edge of the folded ring portion; two opposite sides of the fixed portion are respectively fixed to the stand and the main magnetic yoke; and the folded ring portion protrudes away from the magnetic circuit system.

9. The speaker according to claim 6, wherein a magnetization magnetic circuit for the edge magnetic portion and the first auxiliary magnets is a two-stage magnetization magnetic circuit, and achieves integrated stage-by-stage magnetization or separate magnetization.

10. The speaker according to claim 3, wherein the vibration system comprises two auxiliary sound production units, and the two auxiliary sound production units are oppositely spaced apart from each other in the short axis direction.
